(19) United States
(12) Patent Application Publication
(10) Pub. No.: US 2020/0342351 A1
(43) Pub. Date: Oct. 29, 2020

(54) MACHINE LEARNING TECHNIQUES TO DISTINGUISH BETWEEN DIFFERENT TYPES OF USES OF AN ONLINE SERVICE

(71) Applicant: Microsoft Technology Licensing, LLC, Redmond, WA (US)

(72) Inventors: Suhai Liu, Palo Alto, CA (US); Haowen Cao, Sunnyvale, CA (US); Shen Huang, San Jose, CA (US)

(21) Appl. No.: 16/397,686

(22) Filed: Apr. 29, 2019

(51) Int. Cl. G06N 20/00; G06N 5/04; G06Q 10/06

(52) U.S. Cl. CPC G06N 20/00; G06Q 10/067; G06N 5/04

(57) ABSTRACT

Techniques for using machine learning techniques to distinguish between different types of uses of an online service are provided. In one technique, first training data is used to train a first prediction model and second training data is used to train a second prediction model. The label of training instances in the first training data indicates whether an online action with respect to an online service of one type of action or another type of action. The label of training instances in the second training data indicates whether an entity using the online service initiated a particular action. The first prediction model is used to classify multiple actions performed by an entity relative to the online service. The second prediction model takes the classifications produced by the first prediction model to determine a likelihood that the entity will initiate the particular action.

### TECHNICAL FIELD

The present disclosure relates to machine learning and, more particularly, to analyzing past online activity to generate multiple prediction models for predicting whether users of an online service will initiate a particular action.

### BACKGROUND

With the advent and progression of the Internet, electronic tools for performing almost any type of online activity have become ubiquitous. Some electronic tools are client-side tools that run on a user's client device (e.g., smartphone, laptop computer, or desktop computer) while other electronic tools are web-based tools that execute through a web browser executing on a client device.

Some electronic tools have complementary features that allow users of the tools to access a limited set of features and/or information. Providers of such electronic tools may provide a trial period, during which end users are allowed to access additional features. Such end users are referred to herein as trial users. After the trial period, the additional features are no longer available to a trial user, unless the trial user provides remuneration to retain access to the additional features. Such users are referred to herein as “surviving users.” The trial users who do not become surviving users are referred to as “leaving users.” The ratio of the number of surviving users to trial users is referred to herein as the survival rate.

In many instances, the survival rate is relatively low. Identifying likely leaving users who are relatively close to become surviving users would help in improving the survival rate. Engagement is one factor in identifying such “on-the-fence” users. If a trial user is engaged with the electronic tool, then the trial user is more likely to become a surviving user. Conversely, if a trial user is not engaged with the electronic tool, then the trial user is less likely to become a surviving user. However, identifying whether someone is engaged with an electronic tool is not straightforward since the electronic tool may be used for its traditional (or complementary) purposes and not for the trial purposes. Distinguishing between different types of engagement makes identifying potentially leaving users very difficult.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for employing machine learning techniques to identify potentially leaving users of an electronic tool, in an embodiment;

FIG. 2 is a flow diagram that depicts a process for predicting whether a trial user will perform a particular action, in an embodiment;

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A method and system are provided for predicting whether certain users will perform a particular action based on online behavior exhibited by the users relative to an electronic tool, such as an online service. In one technique, two models are trained: one for classifying online behaviors of one of multiple types and one for predicting, based on the classified behaviors of a particular user, whether the particular user will perform the particular action. The classifying model may take into account, for each online behavior, attributes of the particular user and attributes of an entity with which the particular user interacted. The prediction model may take into account a total number of online behaviors of a first type and a total number of online behaviors of a second type.

Embodiments improve computer technology by proposing a new computer architecture for identifying potentially leaving users without requiring manual review, which is time-consuming, inconsistent, and error prone. Also, embodiments allow computer resources to be conserved by avoiding communicating with users who have little chance of performing the particular action and users who are very likely to perform the particular action and, therefore, do not require individual electronic communications.

### System Overview

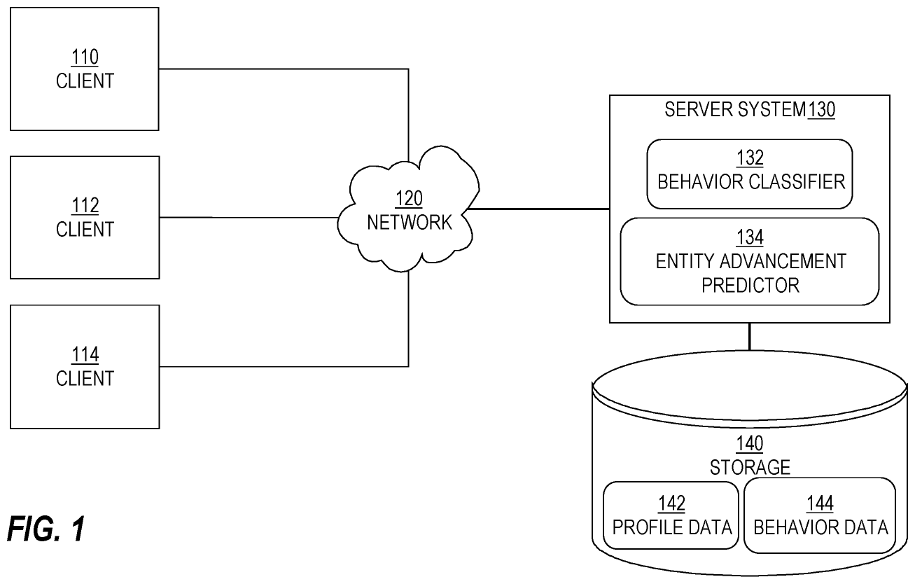

FIG. 1 is a block diagram that depicts a system 100 for employing machine learning techniques to identify potentially leaving users of an electronic tool, in an embodiment. System 100 includes clients 110-114, network 120, server system 130, and storage 140.

Each of clients 110-114 is an application or computing device that is configured to communicate with server system 130 over network 120. Examples of computing devices include a laptop computer, a tablet computer, a smartphone, a desktop computer, and a Personal Digital Assistant (PDA). An example of an application includes a dedicated application that is installed and executed on a local computing device and that is configured to communicate with server system 130 over network 120. Another example of an application is a web application that is downloaded from server system 130 and that executes within a web browser executing on a computing device. Each of clients 110-114 may be implemented in hardware, software, or a combination of hardware and software. Although only three clients 110-114 are depicted, system 100 may include multiple clients that interact with server system 130 over network 120.

Through clients 110-114, users are able to provide input that includes profile information about them. Later, the users may interact with server system 130 to retrieve, supplement, and/or update the profile information.

Network 120 may be implemented on any medium or mechanism that provides for the exchange of data between client 110 and server system 130. Examples of network 120 include, without limitation, a network such as a Local Area Network (LAN), Wide Area Network (WAN), Ethernet or the Internet, or one or more terrestrial, satellite or wireless links.

### Server System

As depicted in FIG. 1, server system 130 includes a behavior classifier 132 and an entity advancement predictor 134. Each of behavior classifier 132 and entity advancement predictor 134 may be implemented in software, hardware, or a combination thereof. Although only two components of server system 130 are depicted, server system 130 may comprise many components that perform different functions and that may be distributed across multiple computing devices in a single network or multiple networks.

Behavior classifier 132 determines whether certain online behaviors or actions are of one type of behavior or another. Such a determination may be based on profile data 142 and behavior data 144 that are stored in storage 140. Behavior classifier 132 is described in more detail below.

Entity advancement predictor 134 determines, based on output (pertaining to a particular entity) from behavior classifier 132, whether the particular entity is likely to perform a particular action, such as subscribing for a particular online service. Entity advancement predictor 134 is described in more detail below.

### Storage

Storage 140 stores profile data 142 and behavior data 144 from which machine-learned models are trained and certain determinations or classifications are made. Storage 140 may comprise persistent storage and/or volatile storage. Storage 140 may comprise multiple storage devices. Also, although depicted separately from server system 130, storage 140 may be part of server system 130 or may be accessed by server system 130 over a local network, a wide area network, or the Internet.

In an embodiment, profile data 142 comprises multiple entity (or user) profiles, each provided by a different entity (or user). In this embodiment, server system 130 maintains accounts for multiple users. Server system 130 may provide a web service, such as a social networking service. Examples of social networking service include Facebook, LinkedIn, and Google+. Although depicted as a single element, server system 130 may comprise multiple computing elements and devices, connected in a local network or distributed regionally or globally across many networks, such as the Internet. Thus, server system 130 may comprise multiple computing elements other than talent flow identifier 132.

A user's profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the user has applied, views of job postings, views of company pages, private messages between the user and other users in the user's social network, and public messages that the user posted and that are visible to users outside of the user's social network.

Some data within a user's profile (e.g., work history) may be provided by the user while other data within the user's profile (e.g., skills and endorsement) may be provided by a third party, such as a “friend” or connection of the user or a colleague of the user.

Before profile data 142 is analyzed, server system 130 may prompt users to provide profile information in one of a number of ways. For example, server system 130 may have provided a web page with a text field for one or more of the above-referenced types of information. In response to receiving profile information from a user's device, server system 130 stores the information in an account that is associated with the user and that is associated with credential data that is used to authenticate the user to server system 130 when the user attempts to log into server system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, server system 130 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by server system 130 (or another automatic process). For example, a user specifies, in his/her profile, a name of the user's employer. Server system 130 determines, based on the name, where the employer and/or user is located. If the employer has multiple offices, then a location of the user may be inferred based on an IP address associated with the user when the user registered with a social network service (e.g., provided by server system 130) and/or when the user last logged onto the social network service.

### Online Behavior

Behavior classifier 132 is a machine-learned classifier that is trained based on multiple training instances, each training instance indicating whether a particular action (or set of actions) is an action/behavior of a first type or of a second type. Example types of actions/behavior include business, personal, education, and entertainment. Although the following description is in the context of a business type and a personal type, embodiments are not so limited.

An online “behavior” is a set of one or more actions performed or initiated by a particular entity or user. Examples of online behavior include selecting (e.g., “clicking”) a particular button, entering text into a search field and initiating a search based on the text, selecting a link, viewing a profile page of an entity (e.g., an organization, group, or user), scrolling through a profile page, composing or drafting an electronic message, causing an electronic message to be transmitted, selecting a notification, selecting a content item (e.g., representing an online article, a blog, a video) in a content item feed that comprises multiple content items, selecting an option associated with a content item (e.g., a like option, a share option, a comment view option to view comments associated with the content item, or a leave comment option to compose a comment for the content item).

A single online behavior may comprise multiple online actions. For example, a single messaging behavior may involve composing a message and then selecting a graphical button or selecting a keyboard key (e.g., “Enter”) to cause the message to the be sent to the intended recipient of the message. An example of a single search behavior may involve a user entering text into a search field, selecting an Enter button to initiate a search, scrolling through search results that are displayed to the user in response to the search, selecting a first link associated with one search result causing a client application to present a first profile page, returning to the search results, and selecting a second link associated with another search result causing the client application to present a second profile page that is different than the first profile page.

Another example of a single online behavior is a user viewing a profile page of a particular entity (e.g., an organization, or another user) and then selecting a request button that causes a message to be sent to the particular entity in order to registered with the particular entity or connected to the particular entity in an online social network. If the particular entity accepts the message, then the user is registered with or connected to the particular entity.

As noted herein, some online behaviors are not clear whether they are for one type of behavior or another. Examples of such behaviors includes an entity search behavior (where the entity may be an organization or another user/member of an online social network), entity browsing behavior (where profiles of entities are requested by the trial user), messaging behavior, and connecting behavior (where the trial user sends and/or accepts connection invitations (or other types of invitations) to/from other users).

In an embodiment, some online behaviors are already classified as (or known to be) of the business type or the personal type. For example, any online behaviors with respect to entities with which a trial user was already connected (or associated) prior to becoming a trial user are automatically labeled as personal behaviors. For example, before becoming a trial user, a first user was connected to a second user in an online social network. Then, after becoming a trial user, the first user composes an electronic message and causes the electronic message to be sent to the second user. Such messaging behavior may be automatically considered as personal behavior since any online behavior with respect to existing contacts/connections may be presumed to be personal in nature.

As another example, any online behaviors with respect to features of the electronic tool that are made available as a result of the user registering to become a trial user are automatically labeled as business behaviors. For example, a feature that becomes available to a trial user through the electronic tool is a lead search feature that is prominently displayed through the electronic tool and invites the trial user to search for potential leads. If the trial user interacts with graphical user interface elements corresponding to the lead search feature, then such interactions are automatically classified as a business type of online behavior.

Other example features of the electronic tool that are associated with business type behaviors include providing lead recommendations, identifying a deal maker in an organization, saving leads, and fundraising. For example, if a trial user initiates a search indicating a search behavior, it might not be clear at the outset whether the search is of the personal type or of the business type. However, if the trial user selects a “save lead” option adjacent to a search result, then the search behavior may be automatically classified as of a business type of behavior. As another example, if a trial user selects a fundraising feature of the electronic tool, then any actions related to the feature are classified as of a business type of behavior. As another example, if a trial user selects any entity (organization or user) presented in a lead recommendation section that includes a list of potential leads that have been automatically identified by the electronic tool for the trial user, then the selection is presumed to be a business type of behavior.

### Behavior Classifier

In order to determine whether at least some online behaviors are of one type or another, a behavior classifier is trained using one or more machine learning techniques.

Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users. The statistical model is trained based on multiple attributes described herein. In machine learning parlance, such attributes are referred to as “features.” To generate and train a statistical prediction model, a set of features is specified and a set of training data is identified.

Embodiments are not limited to any particular machine learning technique for training a behavior classifier. Example machine learning techniques include linear regression, logistic regression, random forests, naive Bayes, and Support Vector Machines (SVMs). Advantages that machine-learned classifiers or prediction models have over rule-based classifiers include the ability of machine-learned classifiers to output a probability (as opposed to a number that might not be translatable to a probability), the ability of machine-learned classifiers to capture non-linear correlations between features, and the reduction in bias in determining weights for different features.

A machine-learned classifier may output different types of data or values, depending on the input features and the training data. For example, training data may comprise, for each user, multiple feature values, each corresponding to a different feature. Example features are outlined herein. In order to generate the training data, information about each user is analyzed to compute the different feature values. In this example, each training instance corresponds to a different online behavior, which may comprise multiple online actions (as described previously). The dependent variable (or label) of each training instance may be whether the online behavior is of one type (e.g., business) or another type (e.g., personal). Thus, some training instances indicate that the corresponding online behavior is of one type and other training instances indicate that the corresponding online behavior is of another type. The training data may be ensured to include at least a certain percentage of training instances being of a particular type, such as 30% or 50% of all training instances in the training data.

Initially, the number of features that are considered for training may be significant. After training a classifier and validating the classifier, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features will little predictive power may be removed from the training data. Removing such features can speed up the process of training future classifiers and making predictions.

### Training Data

In an embodiment, features of behavior classifier 132 includes attributes of the user (or trial user) of the electronic tool and attributes of an entity with which the user interacted. The entity may be another user, an organization (e.g., a company, a charitable organization, a government agency), a group of users, an association, etc.). The “interaction” may be composing a message that is sent to the entity, initiating a connection request to the entity, viewing a profile of the entity, selecting a graphical option providing more information about the entity, and “liking,” sharing, or commenting on an article authored (or otherwise also interacted with) by the entity.

In order to generate a label for each training instance, each corresponding to an online behavior, a human labeler reviews online behavior data (retrieved from behavior data 144) and selects a label, such as ‘1’ for a business type (e.g., for the purpose of sales) and a ‘0’ for a personal type. Privacy of the users and the entities they searched may be ensured by first filtering out, from the online behavior data, any personal information, such as names, gender, and contact information. In this way, human labelers are not exposed to any personal identifying information. Only public data, such as job titles, employers, projects, etc. are provided to judgers. Such public items are enough for the judgement of personal or business behavior.

For each training instance corresponding to an online behavior, feature values are extracted from one or more profiles, such as profile data 142. Example features of behavior classifier 132 include job title, professional experience (examples including seniority, company names of companies worked for, names of one or more industries worked in, years at a current company, years with a current job title, work responsibilities held), skills, academic degrees earned, and academic institutions attended.

Other example features include similarity between certain profile attributes (e.g., job title, job function, industry) of a trial user and an entity with which the trial user interacted. One reason for considering such features is that a trial user (e.g., a sales person) is more likely to interact with people and organizations in the same industry as the trial user for a business purpose while the trial user is more likely to interact with people in different industries for personal purposes.

In an embodiment, time is a factor in behavior classifier 132. For example, the time in which an online behavior occurred relative to a trial period (e.g., a thirty-day period) is taken into account when determining whether an online behavior is of one type or another. For example, training behavior classifier 132 based on training instances may indicate that online behaviors that are classified as business behaviors tend to occur earlier in the trial period.

In an embodiment, natural language processing (NLP) techniques are applied to the input profile data as a part of the training data generation process. Example NLP techniques include term frequency-inverse document frequency (tf-idf), n-gram, stemming, and removing stop words. For example, tf-idf may be used to identify keywords in the profile data, such as a user's work summary, job summary, etc. If two users have similar keywords, then that may be used as a feature in behavior classifier 132. As another example, if two users have similar n-grams (e.g., tri-grams), then that may be used as a feature in behavior classifier 132.

In embodiment, multiple instances of behavior classifier 132 are trained based on different sets of training data. For example, one behavior classifier is trained based on trial users from one country and another behavior classifier is trained based on trial users from another country. As another example, one behavior classifier is trained based on trial users from one industry and another behavior classifier is trained based on trial users from another industry. Other attributes include

### Segmenting Online Behavior Data

In an embodiment, online behavior data that is displayed to a human labeler is first automatically divided into different online behaviors. For example, online behavior data reflecting online behavior of a first trial user is analyzed to identify five instances of online behavior, even though the online behavior data may comprise twenty online actions.

An analyzer (e.g., part of server system 130) may use time information to distinguish actions for one online behavior from actions of another online behavior. For example, actions that are separated by more than ten minutes are presumed to belong to different online behaviors.

The analyzer may also use action type information and one or more behavior templates to identify consecutive actions as belonging to the same or different online behaviors. For example, an online action of clicking on a search result after an online action of initiating a search that produced the search result are identified as belonging to the same online behavior. As another example, after search results of a search are displayed to a trial user, the trial user selects a tab in the electronic tool to view notifications or messages. Because the search action and the tab selection action do not fit into a pre-defined behavior template (which template indicates a typical sequence of online actions indicative of a single online behavior), the analyzer identifies these two actions as belonging to different online behaviors.

### Entity Advancement Predictor

Entity advancement predictor 134 uses output of behavior classifier 132 to generate a prediction of whether a trial user will perform a particular action, which may indicate an advancement of some type. Examples of the particular action include subscribing to the online service (or electronic tool), writing a positive review of the online service, or performing some other online (e.g., social) action indicating a positive experience with the online service.

In an embodiment, entity advancement predictor 134 takes multiple instances of output from behavior classifier 132 with respect to a particular trial user. For example, a trial user may have performed thirty online behaviors with respect to the online service. Some of the thirty online behaviors may have been associated with the same target entity. (For example, the trial user may have sent multiple messages to a particular user and viewed a profile of the particular user multiple times.) Feature values associated with each online behavior is input to behavior classifier 132. Thus, behavior classifier 132 generates thirty classifications.

Alternatively, some of the online behaviors may have been automatically determined to be behaviors of one type or another without using behavior classifier 132. For example, continuing with the example above regarding thirty detected online behaviors, five of the thirty online behaviors may have been automatically assigned to the business type, three of the thirty online behaviors may have been automatically assigned to the personal type, and twenty-two of the remaining online behaviors are used to create twenty-two separate instances of input to behavior classifier 132, which would generate twenty-two classifications, one for each of the twenty-two instances of input.

Entity advancement predictor 134 may implement a rule-based prediction model or a machine-learned prediction model. As an example of a rule-based prediction model, entity advancement predictor 134 may calculate a ratio of (1) the number of online behaviors (that a particular trial user performed using the online service) of the business type to (2) the total number of online behaviors that the particular trial user performed using the online service. In other words:

(number of online business behaviors)/(number of online business behaviors+number of online personal behaviors)

Thus, the total number of online behaviors would include online behaviors of the personal type. The higher the ratio, the more likely the particular trial user will perform a particular action, such as become a subscribing user. A threshold ratio may be defined, such as 2:5, above which entity advancement predictor 134 determines that the trial user will perform the particular action.

As an example of a machine-learned prediction model, training data is generated that includes multiple training instances, each corresponding to a different trial user and a label indicating whether the corresponding trial performed a particular action. Such a label may be generated automatically based on a database containing a history of previous trial users and whether those trial users performed the particular action. Example features of the machine-learned prediction model include the ratio described above, the total number of online behaviors of the business type, and a difference between a rate of usage of the online service prior to becoming a trial user and while being a trial user (e.g., a difference between (1) an average of one online behavior per day for the month prior to becoming a trial user and (2) an average of one and a half online behaviors per day during the trial period).

In an embodiment, the number of predicted online behaviors of one type or another is a non-integer. For example, a first score from behavior classifier 132 based on a first online behavior is 0.9, indicating that there is a 90% likelihood that the first online behavior is of the first type (e.g., a business type) and a second score from behavior classifier 132 based on a second online behavior is 0.4, indicating that there is a 40% likelihood that the second online behavior is of the first type. Thus, based on only these two behaviors, a total number of online behaviors of the first type is 0.9+0.4=1.3. This non-integer value may be used in the prediction model of entity advancement predictor 134. In a related embodiment, only non-integer scores (from behavior classifier 132) above a certain threshold (e.g., 0.5 or 0.75) are used to generate a feature value for the prediction model.

In a related embodiment, scores (from behavior classifier 132) above a certain threshold indicating a positive prediction are translated into integer values. For example, if a score is between 0.75 and 1.0, then the score is considered a value of 1 for purposes of determining a number of online behaviors of a particular type (e.g., a business type). If a score is between 0.5 and 0.75, then the score is considered a value of 0.5 for purposes of determining a number of online behaviors of the particular type. Any score below 0.5 is considered a value of 0 for purposes of determining a number of online behaviors of the particular type. In this example, the total number of online behaviors of the particular type is either an integer or is a multiple of 0.5.

In an embodiment, entity advancement predictor 134 takes into account time when making a prediction regarding a particular trial user. For example, the online behaviors of the first type that occur later in the trial period may be given more weight than online behaviors of the first type that occur earlier in the trial period. Such weights may be manually determined/selected. Alternatively, one or more machine learning techniques may be used to learn the weights. For example, the above ratio (of online behaviors of the first type to all online behaviors) is computed three times: one for the entire trial period (or the trial period up to the current time for a particular trial user), one for the last week, and one for the last day. Thus, online behaviors that occurred on the last day may be used in calculating each of the three ratios. After training entity advancement predictor 134 based on training data with these three values, the result of the training may reveal that the weights for the shorter and/or more recent time periods are higher than the weights for the longer and/or older time periods.

In an embodiment, entity advancement predictor 134 produces a binary output, such ‘1’ for the affirmative prediction that a trial user will perform a particular action and ‘0’ for the negative prediction that the trial user will not perform the particular action. Alternatively, entity advancement predictor 134 produces a range of values, such as floating point values between 0 and 1. Entity advancement predictor 134 may use a threshold that ensures a certain level of precision and/or a certain level of recall. For example, the threshold may ensure maximum precision given 100% recall. As another example, the threshold may ensure maximum recall given 100% precision.

In an embodiment where entity advancement predictor 134 produces variable output (as opposed to binary output), entity advancement predictor 134 (or server system 130) may perform different actions. For example, for trial users with scores between 0 and 0.5, server system 130 performs no action with respect to those trial users; for trial users with scores between 0.5 and 0.75, server system 130 performs a first action with respect to those trial users; for trial users with scores between 0.75 and 1, server system 130 performs a second action with respect to those trial users.

Other example features of the prediction model that entity advancement predictor 134 implements may include attributes of the trial user, such as geographic location/region, job title, job function, industry, skills, past and/or current employers, academic institutions attended academic degrees earned, etc.

### Actions Based on Result of Entity Advancement Predictor

Example actions that server system 130 may perform based on output from entity advancement predictor 134 include sending a personalized message (e.g., email or an instant message), sending promotional content, and offering onboarding assistance. For example, if a score produced by entity advancement predictor 134 for a trial user is within a first range of values, then server system 130 will use a first email template to generate a personalized email to send to the trial user. In contrast, if the score is within a second (different) range of values, then server system 130 will use a second (different) email template to generate a personalized email to send to the trial user.

Server system 130 may only send content to trial users who are predicted to perform the particular action in question. Alternatively, server system 130 may only send content to trial users who are predicted to not perform the particular action in question. Alternatively, server system 130 may only send content to trial users who are associated with an output or score that is within a certain range of values, indicating that the trial user might perform the particular action if extra attention is given to them, whereas for other trial users, their decision is certain.

### Different Types of Electronic Tools/Online Services

Embodiments may be used for different online services that may be in very different domains. For example, embodiments may be used for an electronic sales tool/service that is used to identify and keep track of contacts with which a user is attempting to establish a professional connection. Embodiments may be used for an electronic recruiting tool/service that is used to identify and assist professionals who may be interested in using the service and expertise of a user of the recruiter tool to find a new job opportunity. Embodiments may be used for an electronic learning tool/service that is used to (1) identify relevant online learning courses for personal consumption or for a team of professionals and (2) track the consumption of the online learning courses. Regardless of the online tool or service, the same framework may be used: training an online behavior classifier to classify certain behaviors as one type (e.g., business) or another type (e.g., personal) and then using output from the online behavior classifier with respect to a trial user to predict (using a rule-based model or a machine-learned model) whether the trial user will perform a particular action, such as subscribing for the online service. However, the features of the behavior classifier may be different from one domain or online service to another. For example, a behavior classifier for the sales tool may rely on similarities between profiles of two different users/entities whereas such similarities might not be relevant for a behavior classifier for the learning tool.

### Example Process

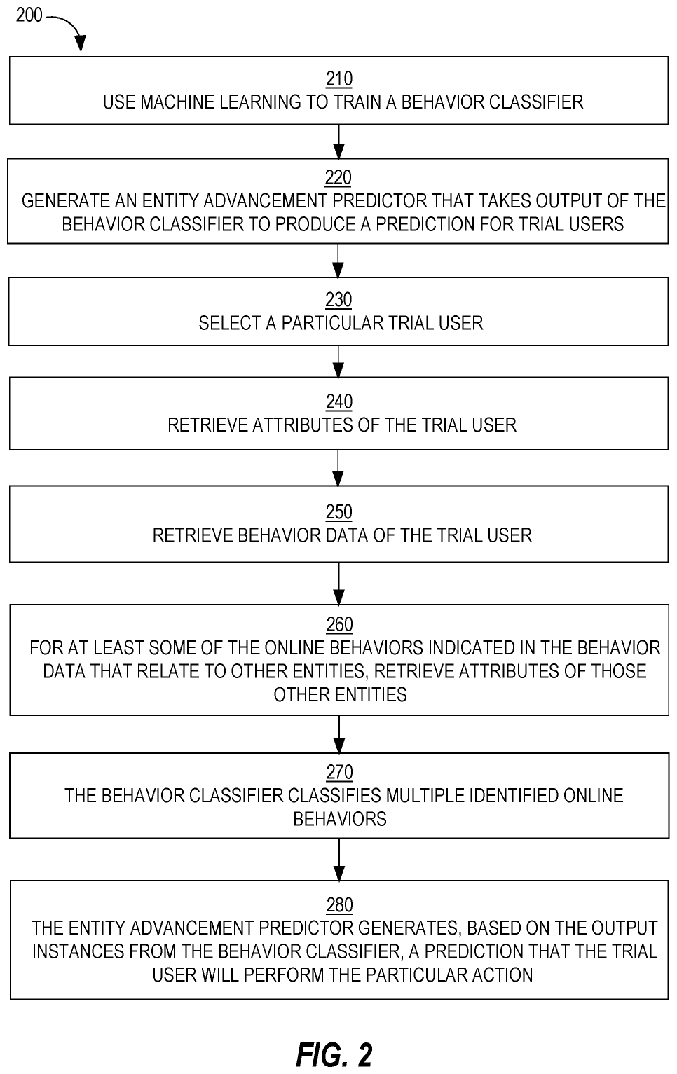

FIG. 2 is a flow diagram that depicts a process 200 for predicting whether a trial user will perform a particular action, in an embodiment. Process 200 may be implemented by components of server system 130 (e.g., behavior classifier 132 and entity advancement predictor 134) relying on data in storage 140 (e.g., profile data 142 and behavior data 144). Process 200 may be performed automatically and periodically, such as every day. Additionally or alternatively, process 200 may be performed for a trial user at one or more times within a trial period of the trial user, such as half way through the trial period and a day before the trial period ends, or every day for the last week of the trial period.

At block 210, one or more machine learning techniques are used to train behavior classifier 132, which may be used for multiple trial users. The training data that is used to train behavior classifier 132 may be based on behavior data of multiple other trials users who have completed their respective trial periods or at least have exhibited some online behavior using the online service/electronic tool. Each training instance in the training data may be labeled manually by human users to indicate whether each identified online behavior of a prior trial user is of one type of behavior (e.g., business) or another (e.g., personal).

At block 220, entity advancement predictor 134 is generated to take output from behavior classifier 132 as input and produce a prediction of whether a trial user corresponding to the input will perform the particular action. Entity advancement predictor 134 may implement a rule-based prediction model or a machine-learned prediction model. Thus, block 220 may involve using one or more machine learning techniques to train the machine-learned prediction model where (1) a label for each training instance used to train the model is whether the corresponding trial user performed the particular action and (2) one or more features of the model are based on a number of online behaviors of one type and a number of online behaviors of another type.

At block 230, a particular trial user is selected. The particular trial user may be a current trial user or one whose trial period with the online service has expired.

At block 240, attributes of the trial user are retrieved. Block 240 may involve retrieving profile data from profile data 142. The user attributes correspond to features of behavior classifier 132. Example attributes include job title, professional experience, industry, job function, and academic degrees.

At block 250, behavior data of the trial user is retrieved. Block 250 may involve retrieving the behavior data from behavior data 144. The behavior data may already be segmented such that, if the trial user has multiple distinct online behaviors, the behavior data distinguishes one online behavior from another online behavior. Alternatively, block 250 may involve segmenting the behavior data of the trial user using one or more techniques described herein, such as timing and/or matching consecutive actions to one or more behavior templates.

At block 260, for online behaviors where it is not clear whether the online behavior is of one type or another and the online behavior involves another entity (e.g., a user or an organization), attributes of the other entity are identified. Values of such attributes may be retrieved from profile data 142. The entity attributes correspond to (and/or are used to generate) features of behavior classifier 132. In the context of the entity being another user, example attributes may be some of those attributes for the trial user, such as job title, industry, job function, etc.

At block 270, for each online behavior identified in block 260, behavior classifier 134 generates output that classifies whether the online behavior is of one type or another. Block 270 may also involve determining a time of each identified online behavior and using the time to generate a feature value as one of the inputs to behavior classifier 134 for each online behavior. Each instance of output of behavior classifier 132 corresponds to a single online behavior and may be a binary value or a continuous value between two values, such as between 0 and 1. Thus, if there are seventeen online behaviors identified for the trial user, then there are seventeen instances of output.

At block 280, entity advancement predictor 136 generates, based on the output instances from behavior classifier 134, a prediction that the trial user will perform the particular action. For example, input to entity advancement predictor 136 may comprise four values: a number of online behaviors of a first type, a ratio of the number of online behaviors of the first type to the number of online behaviors of all types over the entire trial period, a ratio of the number of online behaviors of the first type to the number of online behaviors of all types over the most recent week of the trial period, a ratio of the number of online behaviors of the first type to the number of online behaviors of all types over the most recent day of the trial period. The model that entity advancement predictor 136 implements may include a weight (whether manually tuned or machine learned) for each of one or more these inputs.

Blocks 230-280 may be performed repeatedly for different trial users.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

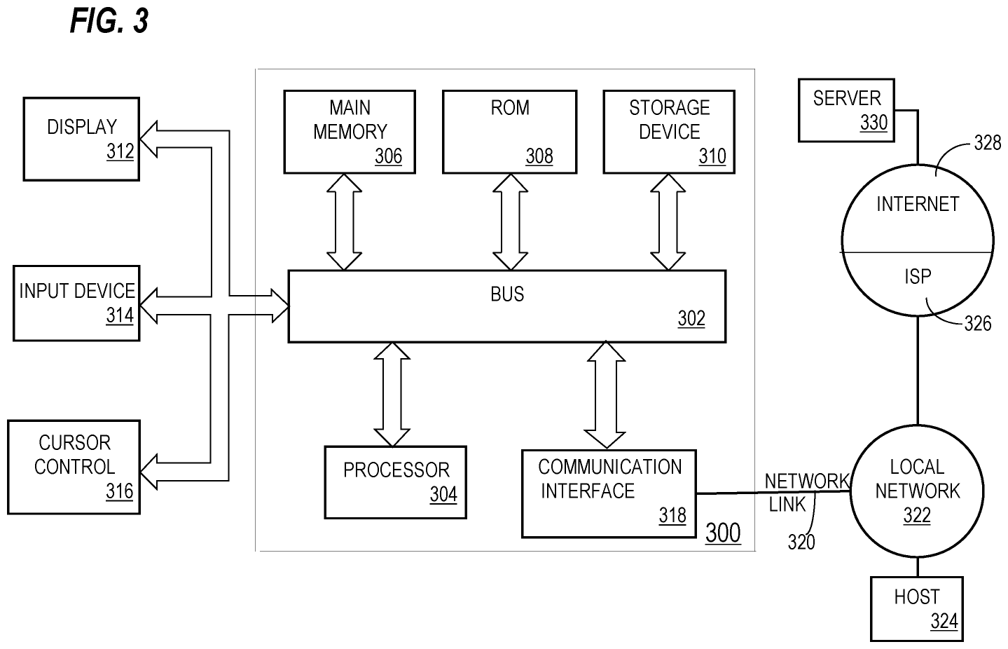

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing first training data that comprises a first plurality of training instances, each corresponding to an online action with respect to an online service and comprising a plurality of feature values and a first label indicating whether the online action is a first type of action or a second type of action that is different than the first type;
using one or more first machine learning techniques to train a first prediction model based on the first training data;
storing second training data that comprises a second plurality of training instances, each corresponding to an entity that used the online service and comprising a set of feature values and a second label indicating whether the entity initiated a particular action;
using one or more second machine learning techniques to train a second prediction model based on the second training data;
using the first prediction model to classify each action of a first plurality of actions performed by a first entity relative to the online service;
based on a first plurality of classifications of the first plurality of actions, using the second prediction model to determine a likelihood of the first entity initiating the particular action;
wherein the method is performed by one or more computing devices.

2. The method of claim 1, wherein:
a feature in a set of one or more features of the second prediction model is based on a first number of actions of the first type and a second number of actions of the second type;
the first number is based on a first subset of the first plurality of classifications.

3. The method of claim 2, wherein the feature is the first number divided by a sum of the first number and the second number and a weight of the feature is machine-learned.

4. The method of claim 2, wherein the first number is also based on actions that were automatically determined, independent of the first prediction model, to be of the first type.

5. The method of claim 2, wherein:
the feature is a first feature that corresponds to a first time period in which the actions of the first number of actions and the second number of actions occurred;
a set of features corresponding to the set of feature values includes a second feature that corresponds to a second time period that is different than the first time period;
the second feature is based on a third number of actions of the first type and a fourth number of actions of the second type.

6. The method of claim 1, wherein a set of features of the first prediction model is based on (1) profile features of a first entity that used the online service and (2) profile features of a second entity that is a subject of content with which the first entity interacted using the online service.

7. The method of claim 6, wherein the profile features of the first entity include one or more of a current or former job title, academic background, current or former employer, and skills.

8. The method of claim 6, wherein the set of features includes a measure of similarity between one or more profile features of the first entity and one or more profile features of the second entity.

9. One or more storage media storing instructions which, when executed by one or more processors, cause:
storing first training data that comprises a first plurality of training instances, each corresponding to an online action with respect to an online service and comprising a plurality of feature values and a first label indicating whether the online action is a first type of action or a second type of action that is different than the first type;
using one or more first machine learning techniques to train a first prediction model based on the first training data;
storing second training data that comprises a second plurality of training instances, each corresponding to an entity that used the online service and comprising a set of feature values and a second label indicating whether the entity initiated a particular action;
using one or more second machine learning techniques to train a second prediction model based on the second training data;
using the first prediction model to classify each action of a first plurality of actions performed by a first entity relative to the online service;
based on a first plurality of classifications of the first plurality of actions, using the second prediction model to determine a likelihood of the first entity initiating the particular action.

10. The one or more storage media of claim 9, wherein:
a feature in a set of one or more features of the second prediction model is based on a first number of actions of the first type and a second number of actions of the second type;
the first number is based on a first subset of the first plurality of classifications.

11. The one or more storage media of claim 10, wherein the feature is the first number divided by a sum of the first number and the second number and a weight of the feature is machine-learned.

12. The one or more storage media of claim 10, wherein the first number is also based on actions that were automatically determined, independent of the first prediction model, to be of the first type.

13. The one or more storage media of claim 10, wherein:
the feature is a first feature that corresponds to a first time period in which the actions of the first number of actions and the second number of actions occurred;
a set of features corresponding to the set of feature values includes a second feature that corresponds to a second time period that is different than the first time period;
the second feature is based on a third number of actions of the first type and a fourth number of actions of the second type.

14. The one or more storage media of claim 9, wherein a set of features of the first prediction model is based on (1) profile features of a first entity that used the online service and (2) profile features of a second entity that is a subject of content with which the first entity interacted using the online service.

15. The one or more storage media of claim 14, wherein the profile features of the first entity include one or more of a current or former job title, academic background, current or former employer, and skills.

16. The one or more storage media of claim 14, wherein the set of features includes a measure of similarity between one or more profile features of the first entity and one or more profile features of the second entity.

17. A system comprising:
one or more processors;
one or more storage media storing instructions which, when executed by the one or more processors, cause:
storing first training data that comprises a first plurality of training instances, each corresponding to an online action with respect to an online service and comprising a plurality of feature values and a first label indicating whether the online action is a first type of action or a second type of action that is different than the first type;
using one or more first machine learning techniques to train a first prediction model based on the first training data;
storing second training data that comprises a second plurality of training instances, each corresponding to an entity that used the online service and comprising a set of feature values and a second label indicating whether the entity initiated a particular action;
using one or more second machine learning techniques to train a second prediction model based on the second training data;
using the first prediction model to classify each action of a first plurality of actions performed by a first entity relative to the online service;
based on a first plurality of classifications of the first plurality of actions, using the second prediction model to determine a likelihood of the first entity initiating the particular action.

18. The system of claim 17, wherein:
a feature in a set of one or more features of the second prediction model is based on a first number of actions of the first type and a second number of actions of the second type;
the first number is based on a first subset of the first plurality of classifications.

19. The system of claim 17, wherein a set of features of the first prediction model is based on (1) profile features of a first entity that used the online service and (2) profile features of a second entity that is a subject of content with which the first entity interacted using the online service.

20. The system of claim 19, wherein the set of features includes a measure of similarity between one or more profile features of the first entity and one or more profile features of the second entity.
